(19) United States
(12) Patent Application Publication
(10) Pub. No.: US 2023/0051330 A1
(43) Pub. Date: Feb. 16, 2023

(54) USING DEFECT MODELS TO ESTIMATE DEFECT RISK AND OPTIMIZE PROCESS RECIPES

(71) Applicant: Applied Materials Inc., Santa Clara, CA (US)

(72) Inventors: Dermot P. Cantwell, Sunnyvale, CA (US); Changgong Wang, San Jose, CA (US); Nasreen Chopra, Portola Valley, CA (US); Moon Kyu Oh, Santa Clara, CA (US)

(21) Appl. No.: 17/402,832

(22) Filed: Aug. 16, 2021

(51) Int. Cl. G06F 30/27

(52) U.S. Cl. CPC G06F 30/27; G06F 2119/02

(57) ABSTRACT

A system includes a memory and a processing device, operatively coupled to the memory, to perform operations including receiving, as input to a trained machine learning model for identifying defect impact with respect to at least one type defect type, data associated with a process related to electronic device manufacturing. The data associated with the process comprises at least one of: an input set of recipe settings for processing a component, a set of desired characteristics to be achieved by processing the component, or a set of constraints specifying an allowable range for each setting of the set of recipe settings. The operations further include obtaining an output by applying the data associated with the process to the trained machine learning model. The output is representative of the defect impact with respect to the at least one defect type.

### TECHNICAL FIELD

Embodiments of the present disclosure relate, in general, to manufacturing systems and more particularly to using defect models to estimate defect risk and optimize process recipes.

### BACKGROUND

Semiconductor wafer processing complexity has been increasing as the device size has been shrinking. A typical process has multiple different steps, with some advanced processes, such as plasma etching, may have twenty or even more steps. Each step has a multitude of knobs associated to optimize performance. Therefore, the space available to tune and optimize a given process is theoretically extremely large.

Process engineers use their experience and expertise to select a preliminary baseline process and fine-tune the process based on a limited number of wafers (or portions of wafers, referred to as coupons) dedicated for design of experiment (DoE). The goal of DoE is to tailor the process to achieve desired specification on a wafer. However, dedicating full wafers or portions of wafers for DoE data collection consume valuable resources. Therefore, often the adopted process may be a viable one, but not necessarily the optimum solution.

Another bottleneck is introduced by insufficient in-line precision metrology data. For precision metrology, usually destructive techniques, such as inductively-coupled plasma mass spectrometry (ICP-MS), are used. However, since ICP-MS can be very time consuming, it generally does not generate enough statistical data and can be subject to strong substrate/film interference. Also, ICP-MS cannot be effectively integrated into the production line because it is a destructive technique.

### SUMMARY

In some embodiments, a method is provided. The method receiving, by a processing device, training input data associated with a process related to electronic device manufacturing. The training input data includes a set of experimental data related to the process. The method further includes obtaining, by the processing device, target output data for the training input data. The target output data identifies a set of defect types. The method further includes providing, by the processing device, the training input data and the target output data to train a set of machine learning models. Each machine learning model of the set of machine learning models is trained for identifying defect impact with respect to at least one type defect type of the set of defect types.

In some embodiments, a system is provided. The system includes a memory and a processing device, operatively coupled to the memory, to perform operations including receiving, as input to a trained machine learning model for identifying defect impact with respect to at least one type defect type, data associated with a process related to electronic device manufacturing. The data associated with the process comprises at least one of: an input set of recipe settings for processing a component, a set of desired characteristics to be achieved by processing the component, or a set of constraints specifying an allowable range for each setting of the set of recipe settings. The operations further include obtaining an output by applying the data associated with the process to the trained machine learning model. The output is representative of the defect impact with respect to the at least one defect type.

In some embodiments, a non-transitory computer readable storage medium is provided. The non-transitory computer readable storage medium includes instructions that, when executed by a processing device, cause the processing device to perform operations including receiving, as input to a trained machine learning model for identifying defect impact with respect to at least one type defect type, data associated with a process related to electronic device manufacturing. The data associated with the process comprises at least one of: an input set of recipe settings for processing a component, a set of desired characteristics to be achieved by processing the component, or a set of constraints specifying an allowable range for each setting of the set of recipe settings. The operations further include obtaining an output by applying the data associated with the process to the trained machine learning model. The output is representative of the defect impact with respect to the at least one defect type.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 depicts an illustrative computer system architecture, according to aspects of the present disclosure.

FIG. 2 is a block diagram of a system for using defect models to generate process recipes, according to aspects of the present disclosure.

FIG. 3 is a flow chart of a method for using at least one trained defect model to generate a process recipe, according to aspects of the present disclosure.

FIG. 4 is a flow chart of a method for obtaining defect model training data based on input training data to generate at least one trained defect model, according to aspects of the present disclosure.

FIG. 5 is a flow chart of a method for tuning at least one initial trained defect model to generate at least one trained defect model, according to aspects of the present disclosure.

FIG. 6 depicts a block diagram of an illustrative computing device operating in accordance with one or more aspects of the present disclosure.

### DETAILED DESCRIPTION OF EMBODIMENTS

Implementations described herein provide for process recipe creation using machine learning models for semiconductor device defects. Process recipe creation is typically an iterative process. Process conditions that can cause defects may not be known until a wafer or substrate is run and post-process metrology is performed. Experimental and expert knowledge can help guide this process. Conventional methods do not systemically capture this information. In addition, defects are often the net results of multiple physical and/or chemical processes with varying sources and generation mechanisms, which can make data interpretation challenging, especially considering the potential interaction of different variables.

Aspects of the present disclosure address the above noted and other deficiencies by providing for process recipe creation using machine learning models for semiconductor device defects. A processing device for a manufacturing system can provide, as input to a trained machine learning model, data associated with a process recipe. In some embodiments, the processing device can receive the data from a client device for the manufacturing system. A user (e.g., an operator, an engineer, etc.) can provide the data associated with the process recipe via a graphical user interface (GUI) of the client device and the client device can transmit the received data to the processing device for the manufacturing system.

The machine learning model can be trained to predict semiconductor device defects and/or probability of semiconductor device defects impacting on-wafer performance. The machine learning model can be trained using training data obtained from a number of sources with respect to defect generation versus recipe conditions. From the training data, a set of models including a classification model and/or a regression model can be created. Depending on the defect type and use case, the set of models can estimate the probability of defects, estimate defect count, and segment a process space into a number of regions (e.g., a good region, a warning region, and a bad (fault) region). The set of models can be used in conjunction with process development tools to provide additional guidance with respect to the estimated defect performance for any modeled process condition, and can achieve co-optimization for both process and defect performance. This additional guidance can deter process development from straying into spaces where defect probability is high. Numerical optimizers can be added to assist in suggesting alternate process settings that can minimize the potential for defects. The set of models can then be utilized during semiconductor device manufacturing to accelerate and guide process recipe creation by providing feedback on the potential risk of defect generation for a given process condition before processing a wafer. By applying the settings for the process recipe that are obtained based on the output of the trained machine learning model, semiconductor device defects can be significantly reduced. Accordingly, a fewer number of substrates and/or components of a process chamber are defective, which improves an overall throughput and efficiency of a manufacturing system/process.

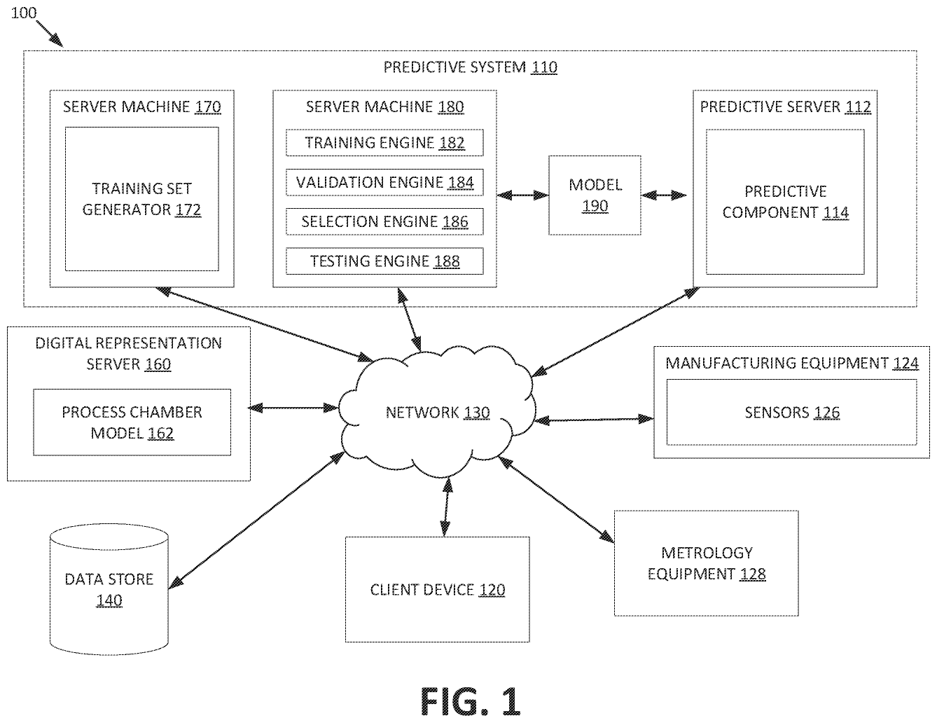

FIG. 1 depicts an illustrative computer system architecture 100, according to aspects of the present disclosure. Computer system architecture 100 can include a client device 120, a predictive server 112 (e.g., to generate predictive data, to provide model adaptation, to use a knowledge base, etc.), and a data store 140. The predictive server 112 can be part of a predictive system 110. The predictive system 110 can further include server machines 170 and 180. In some embodiments, computer system architecture 100 can be included as part of a manufacturing system for processing substrates or wafers. In such embodiments, computer system architecture 100 can include manufacturing equipment 124, metrology equipment 128 and/or testing equipment (not shown).

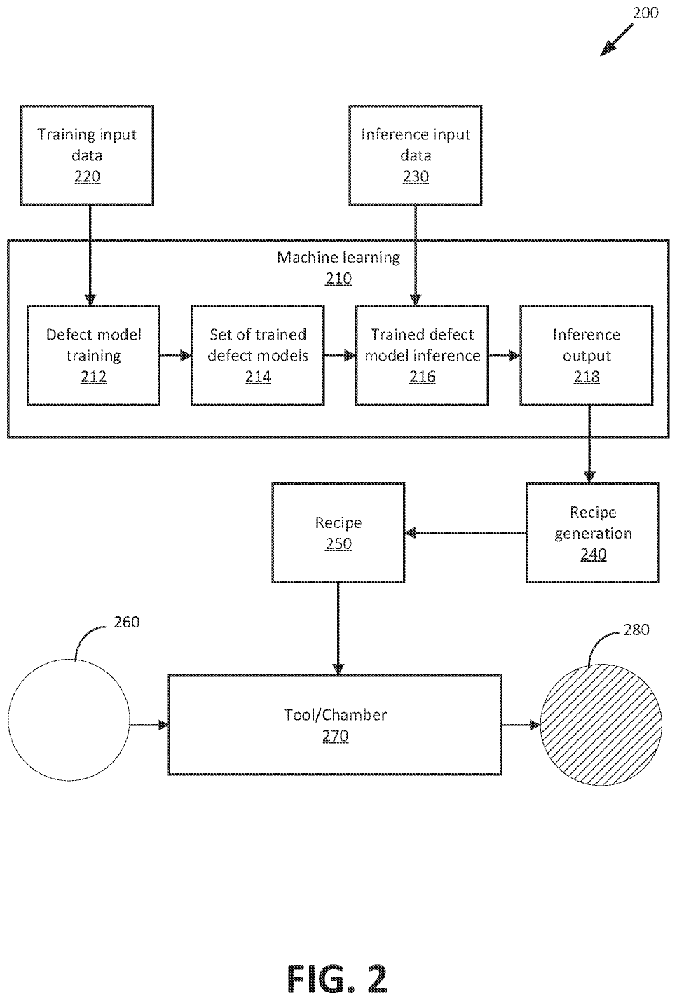

Manufacturing equipment 124 can produce products, such as electronic devices, following a recipe or performing runs over a period of time. Manufacturing equipment 124 can include a process chamber, such as process chamber 200 described with respect to FIG. 2. Manufacturing equipment 124 can perform a process for a wafer (e.g., a wafer, etc.) at the process chamber. Examples of wafer processes include a deposition process to deposit a film on a surface of the wafer, an etch process to form a pattern on the surface of the wafer, a wafer heating process to heat a wafer to a target temperature prior to a deposition process or an etch process, a wafer cooling process to cool a wafer to a target temperature following a deposition process and/or an etch process, etc. Manufacturing equipment 124 can perform each process according to a process recipe. A process recipe defines a particular set of operations to be performed for the wafer during the process and can include one or more settings associated with each operation. For example, a wafer heating process can include a positional setting for the wafer disposed within the process chamber, a temperature setting for the process chamber, a pressure setting for the process chamber, a pressure setting for the process chamber, etc.

In some embodiments, manufacturing equipment 124 can include one or more sensors 126 configured to generate process sensor data for an environment within or outside of a process chamber and/or a wafer disposed within the process chamber. Sensor data can include a value of one or more of temperatures (e.g., heater temperature), spacing (SP), pressure, high frequency radio frequency (HFRF), voltage of electrostatic chuck (ESC), electrical current, flow, power, voltage, etc. Sensor data can be associated with or indicative of manufacturing parameters such as hardware parameters, such as settings or components (e.g., size, type, etc.) of the manufacturing equipment 124, or process parameters of the manufacturing equipment 124. The sensor data can be provided while the manufacturing equipment 124 is performing manufacturing processes (e.g., equipment readings when processing products). The sensor data can be different for each wafer processed at manufacturing equipment 124.

Metrology equipment 128 can provide metrology data associated with wafers (e.g., wafers, etc.) processed by manufacturing equipment 124. In some embodiments, metrology data can include data generated for a film on a surface of a wafer before, during, or after a deposition and/or an etch process is performed for that wafer. For example, metrology data can include a value of film property data (e.g., wafer spatial film properties), dimensions (e.g., thickness, height, etc.), dielectric constant, dopant concentration, density, defects, etc. generated for a wafer after completion of a wafer process. In some embodiments, the metrology data can further include data associated with a portion of a wafer that is not subject to a deposition and/or an etch process. For example, a film can be deposited on a top surface of a wafer prior to an etch process that is to etch away a portion of the film and create a target wafer surface pattern. A wafer heating process can initiated for the wafer to heat the wafer to a target temperature prior to initiate of the etch process.

The client device 120 can include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. In some embodiments, computer system architecture 100 can receive data associated with a process recipe for a process to be performed for a wafer at manufacturing equipment 124 from client device 120. For example, client device 120 can display a graphical user interface (GUI), where the GUI enables a user (e.g., an engineer, an operator, a developer, etc.) to provide, as input, data associated with one or more process recipe settings for a wafer heating process and/or a wafer cooling process to be performed for a wafer at a process chamber of manufacturing equipment 124.

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). In some embodiments, data store 140 can store sensor data, metrology data, predictive data, and/or contextual data. Sensor data can include historical sensor data (e.g., sensor data generated by sensors 126 for a previous wafer processed at manufacturing equipment 124) and/or current sensor data (e.g., sensor data generated by sensors 126 for a current wafer being processed at manufacturing equipment 124). In some embodiments, current sensor data can be data for which predictive data is generated. Sensor data can include but is not limited to, data indicating a temperature of one or more components of manufacturing equipment 124 (e.g., a temperature of a lid and/or a window of a process chamber, a temperature of a heating element embedded within a wafer support assembly of the process chamber, etc.), data indicating a temperature of a wafer during a wafer process, data indicating a pressure at one or more portions of an environment within manufacturing equipment 124 (e.g., a pressure of the environment between a lid and/or window of a process chamber and a surface of a wafer, a pressure of the environment between a surface of a wafer and a surface of a wafer support assembly, etc.), data indicating a concentration or flow rate of one or more gases flowed into manufacturing equipment 124 before, during and/or after a wafer process, and so forth. Data store can store metrology data, in some embodiments. Metrology data can include historical metrology data (e.g., metrology data generated by metrology equipment 128 for a previous wafer processed at manufacturing equipment 124).

Contextual data refers to data associated with a wafer and/or a wafer process performed at manufacturing equipment 124. In some embodiments, contextual data can include data associated with the wafer (e.g., such as an identifier for a wafer, a type of the wafer, etc.). Contextual data can additionally or alternatively include data associated with one or more components of manufacturing equipment 124 used to process the wafer. For example, contextual data can include an identifier for the one or more components of manufacturing equipment 124, one or more physical properties associated with the one or more components (e.g. an emissivity of the one or more components, a molecular weight of the one or more components, etc.), an identifier associated with an operator of manufacturing equipment 124, a type of the process performed at manufacturing equipment 124, etc.

In additional or alternative embodiments, contextual data can include data associated with a process recipe performed for the wafer at manufacturing equipment 124. For example, contextual data can include an identifier of a name for the process recipe, an operation number for an operation of the process recipe, or settings for one or more operations of the process recipe (referred to herein as a process recipe setting). A process recipe setting can include a positional setting for the wafer or one or more components of manufacturing equipment 124, such as a setting for a position of a wafer disposed within a process chamber relative to a lid and/or a window of the process chamber, a position of the wafer relative to a wafer support assembly of the process chamber, a position of the wafer support assembly relative to the lid and/or the window of the process chamber, a velocity of a movement of the wafer support assembly (with or without a wafer) toward or away from the lid and/or the window of the process chamber, a velocity of a movement of the wafer toward or away from a surface of the wafer support assembly, etc. A process recipe setting can also include a temperature and/or pressure setting for one or more components of manufacturing equipment 124 and/or the wafer disposed within manufacturing equipment 124. A process recipe setting can also include a gas flow setting for the wafer process, including a setting indicating a target composition and/or concentration of a gas flowed into a process chamber of manufacturing equipment 124, a flow rate of the gas flowed into the process chamber, a temperature of the gas flowed into the process chamber, etc.

Contextual data can include historical contextual data (e.g., contextual data for a prior wafer process performed for a prior wafer at manufacturing equipment 124) and/or current contextual data (e.g., contextual data for a wafer process currently performed or to be performed for a current wafer at manufacturing equipment 124). Current contextual data can be data for which predictive data is generated, in accordance with embodiments described herein. Historical contextual data and/or current contextual data can be provided to system 100 via a GUI of client device 120, in accordance with previously described embodiments.

In some embodiments, data store 140 can be configured to store data that is not accessible to a user of the manufacturing system. For example, testing data, contextual data, etc. for a wafer support assembly is not accessible to a user (e.g., an operator) of the manufacturing system and/or testing system. In some embodiments, all data stored at data store 140 can be inaccessible by the user of the system. In other or similar embodiments, a portion of data stored at data store 140 can be inaccessible by the user while another portion of data stored at data store 140 can be accessible by the user. In some embodiments, one or more portions of data stored at data store 140 can be encrypted using an encryption mechanism that is unknown to the user (e.g., data is encrypted using a private encryption key). In other or similar embodiments, data store 140 can include multiple data stores where data that is inaccessible to the user is stored in one or more first data stores and data that is accessible to the user is stored in one or more second data stores.

In some embodiments, predictive system 110 can include a server machine 170 and/or a server machine 180. Server machine 170 includes a training set generator 172 that is capable of generating training data sets (e.g., a set of data inputs and a set of target outputs) to train, validate, and/or test a machine learning model 190. For example, training set generator 172 can generate training sets to train, validate, and/or test machine learning model 190 to predict process recipe settings for a process to be performed for a wafer at manufacturing equipment 124, in accordance with embodiments provided herein.

In some embodiments, training set generator 172 can generate training sets for machine learning model 190 based on historical sensor, metrology, and/or contextual data associated with one or more prior wafer processes performed at manufacturing equipment 124. In additional or alternative embodiments, training set generator 172 can generate training sets for machine learning model 190 based on predictive or simulated sensor, metrology, and/or contextual data generated by a digital replica model (e.g., digital twin) of manufacturing equipment 124. A digital replica model (also referred to as a digital replica herein) can be an algorithmic model that simulates manufacturing equipment 124, in some embodiments.

In some embodiments, digital representation server 160 can be a digital replica of manufacturing equipment 124. Digital representation server 160 can use supervised machine learning, semi-supervised learning, unsupervised machine learning, or any combination thereof to generate a virtual representation of the physical elements and/or the dynamics of how manufacturing equipment 124 operations. Digital representation server 160 can be updated via reinforcement learning using periodic updates from sensors 126 and/or data associated with generating and maintaining the digital replica data of manufacturing equipment 124, such as sensor data, performance data (e.g., data associated with an efficiency, latency, throughput, etc. of one or more components of manufacturing equipment 124), library data, etc. In some embodiments, digital representation server 160 can include a processing chamber model 162 that is associated with the physical elements and dynamics of a process chamber of manufacturing equipment 124.

Digital representation server 160 can generate simulation data that is used to determine how manufacturing equipment 124 would perform based on current or simulated parameters. The simulation data can be stored at data store 140, in some embodiments. In some embodiments, the simulation data can include one or more process recipe settings associated with a wafer process for a wafer at a process chamber. The simulation data can also include predicted property data and/or predicted metrology data (e.g., virtual metrology data) of the digital replica of manufacturing equipment 124 (e.g., of products to be produced or that have been produced using current sensor data at data store 140). The simulation data can also include an indication of abnormalities (e.g., abnormal products, abnormal components, abnormal manufacturing equipment 124, abnormal energy usage, etc. and one or more causes of the abnormalities. The simulation data can further include an indication of an end of life of a component of manufacturing equipment 124. The simulation data can be all encompassing, covering every mechanical and/or electrical aspect of manufacturing equipment 124.

As described above, training set generator 172 can generate training data for model 190 based on predictive or simulated data obtained from digital representation server 160. For example, training set generator 172 can generate one or more sets of process recipe settings and provide the sets of process recipe settings to digital representation server 160 to simulate a process at a process chamber of manufacturing equipment 124 using process chamber model 162. In some embodiments, the data output by process chamber model 162 can include a pressure differential between a first space of the process chamber environment and a second space of the process chamber environment. The first space of the process chamber environment can include a space between a top surface of the wafer and a ceiling (e.g., a lid, a window, etc.) of the process chamber. The second space of the process chamber environment can include a space between a bottom surface of the wafer and a top surface of a wafer support assembly that supports the wafer during the simulated wafer process. In additional or alternative embodiments, the data output by process chamber model 162 can include data associated with a rate of change of a temperature of the wafer between an initial period of the wafer process and a final period of the wafer process (referred to as a ramping rate). In some embodiments, the training set generator 172 can partition the training data (e.g., data for a physical process and/or simulated data) into a training set, a validating set, and a testing set. In some embodiments, the predictive system 110 generates multiple sets of training data. Some operations of training set generator 172 are described in detail below with respect to FIG. 2.

Server machine 180 can include a training engine 182, a validation engine 184, a selection engine 186, and/or a testing engine 188. An engine can refer to hardware (e.g., circuitry, dedicated logic, programmable logic, microcode, processing device, etc.), software (such as instructions run on a processing device, a general purpose computer system, or a dedicated machine), firmware, microcode, or a combination thereof. Training engine 182 can be capable of training a machine learning model 190. The machine learning model 190 can refer to the model artifact that is created by the training engine 182 using the training data that includes training inputs and corresponding target outputs (correct answers for respective training inputs). The training engine 182 can find patterns in the training data that map the training input to the target output (the answer to be predicted), and provide the machine learning model 190 that captures these patterns. The machine learning model 190 can use one or more of classification, support vector machine (SVM), Radial Basis Function (RBF), clustering, supervised machine learning, semi-supervised machine learning, unsupervised machine learning, k-nearest neighbor algorithm (k-NN), linear regression, logistic regression, random forest, neural network (e.g., artificial neural network), etc.

The validation engine 184 can be capable of validating a trained machine learning model 190 using a corresponding set of features of a validation set from training set generator 172. The validation engine 184 can determine an accuracy of each of the trained machine learning models 190 based on the corresponding sets of features of the validation set. The validation engine 184 can discard a trained machine learning model 190 that has an accuracy that does not meet a threshold accuracy. In some embodiments, the selection engine 186 can be capable of selecting a trained machine learning model 190 that has an accuracy that meets a threshold accuracy. In some embodiments, the selection engine 186 can be capable of selecting the trained machine learning model 190 that has the highest accuracy of the trained machine learning models 190.

The testing engine 188 can be capable of testing a trained machine learning model 190 using a corresponding set of features of a testing set from data set generator 172. For example, a first trained machine learning model 190 that was trained using a first set of features of the training set can be tested using the first set of features of the testing set. The testing engine 186 can determine a trained machine learning model 190 that has the highest accuracy of all of the trained machine learning models based on the testing sets.

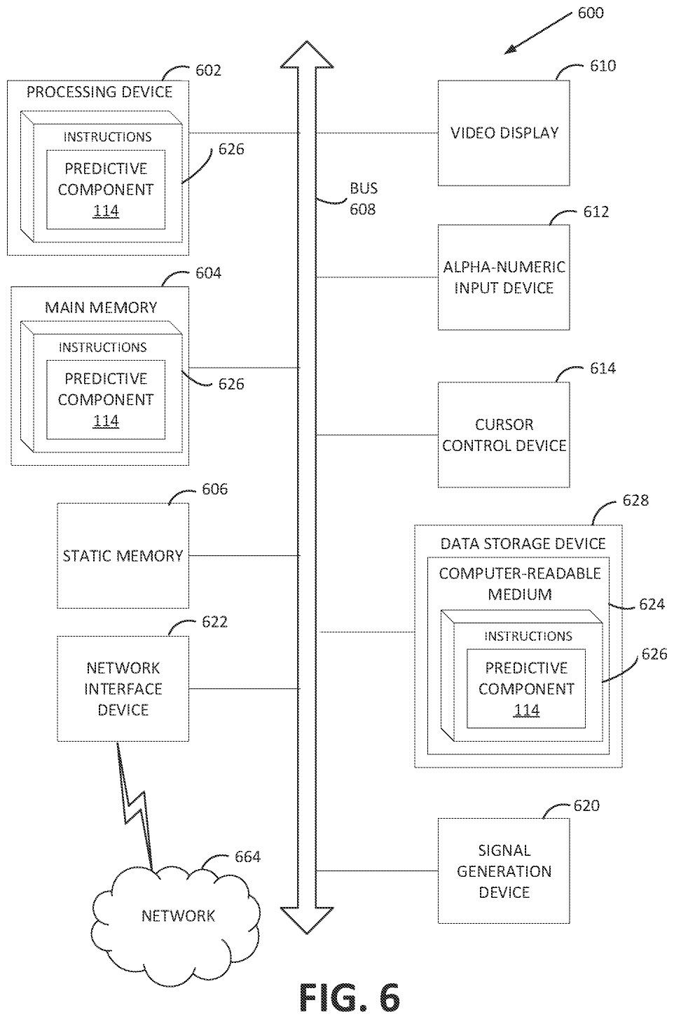

Predictive server 112 includes a predictive component 114 that is capable of providing one or more process recipe settings for a current substrate to be processed at manufacturing equipment 124 and/or data related to defects (e.g., estimate of risk of defects, or expected defect density or count). As described in detail below with respect to FIG. 6, in some embodiments, predictive component 114 is capable of providing data associated with a process recipe for a substrate process to be performed for a substrate as an input to model 190 and obtain one or more outputs of model 190. In some embodiments, the data associated with the process recipe can include an indication of one or more operations to be performed for the process recipe and a target temperature for the substrate at a final period of the substrate process. The process recipe data can include, in some embodiments, one or more target substrate process settings to be applied during the substrate process. Predictive server 112 can a set of process recipe settings that correspond to the one or more operations and/or the target temperature for the substrate based on the one or more outputs of model 190. In response to determining that the determine set of process recipe settings satisfies a level of confidence criterion, predictive server 112 can cause the substrate process to be performed for the substrate at the process chamber in accordance with the determined process recipe settings.

In some embodiments, predictive server 112 can transmit an indication of the one or more process recipe settings to client device 120 as a suggested modification to the one or more target substrate process recipe settings. Client device 120 can display the suggest modifications to the target substrate process recipe settings via a GUI of client device 120. A user (e.g., an operator, an engineer, a developer, etc.) of system 100 can interact with one or more elements of the GUI of client device 120 to cause the substrate process to be initiated or not to be initiated for the substrate in accordance with the one or more process recipe settings obtained from an output of model 190.

The client device 120, manufacturing equipment 124, data store 140, digital representation server 160, predictive server 112, server machine 170, and server machine 180 can be coupled to each other via a network 130. In some embodiments, network 130 is a public network that provides client device 120 with access to predictive server 112, data store 140, and other publically available computing devices. In some embodiments, network 130 is a private network that provides client device 120 access to manufacturing equipment 124, data store 140, digital representation server 160, predictive server 112, and other privately available computing devices. Network 130 can include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

It should be noted that in some other implementations, the functions of digital representation server 160, server machines 170 and 180, as well as predictive server 112, can be provided by a fewer number of machines. For example, in some embodiments, digital representation server 160, server machine 170 and/or server machine 180 can be integrated into a single machine, while in some other or similar embodiments, digital representation server 160, server machine 170 and/or server machine 180, as well as predictive server 112, can be integrated into a single machine.

In general, functions described in one implementation as being performed by digital representation server 160, server machine 170, server machine 180, and/or predictive server 112 can also be performed on client device 120. In addition, the functionality attributed to a particular component can be performed by different or multiple components operating together.

In embodiments, a “user” can be represented as a single individual. However, other embodiments of the disclosure encompass a “user” being an entity controlled by a plurality of users and/or an automated source. For example, a set of individual users federated as a group of administrators can be considered a “user.”

FIG. 2 is a diagram of a system 200 for using defect models to generate process recipes, according to aspects of the present disclosure. As shown, the system 200 includes a machine learning section 210. The machine learning section 210 can including a defect model training component 212 that receives input training data 220 to generate a set of trained defect models 214. The set of trained defect models 214 can include one or more trained defect models each corresponding to a respective defect type. A defect can be defined as any undesired on-wafer condition or feature (e.g., particles, contamination).

The input training data 220 can include, for example, a set of experimental data and/or a set of expert knowledge. The set of expert knowledge can include data mined from one or more expert sources. Examples of expert sources include literature, in-house expertise, expert intuition, etc.

For example, the set of experimental data can include a set of physics model data. The set of physics model data can include one or more physics-based models. The set of experimental data can include data from structured experiments (structured experimental data) and/or a data from unstructured experiments (unstructured experimental data). Structure experimental data refers to experimental data that is obtained based on a defined structure (e.g., mathematical structure), whereas unstructured experimental data refers to experimental data that is not obtained based on a defined structure (e.g., from external sources such as publications).

For example, the structured experimental data can include Design of Experiment (DoE) data obtained using DoE techniques. For example, DoE techniques can be used to detect wafer sensitivity in view of changing recipe parameters. DoE is the design of any information-gathering exercise where variation is present, and DoE analysis is the analysis of data generated from execution of a DoE (i.e., DoE data). In some implementations, DOE data includes recipe parameters, recipe parameter values, and measurements (e.g., wafer measurements). For example, for a DoE analysis in which five recipe parameters may be varied, a DoE can be performed by running multiple experiments where each of the five recipe parameters is varied according to predetermined values for each experiment. Wafers from each experiment may then be measured at various locations and associated with their corresponding recipe parameters. Sensitivity values may be calculated by comparing the variation in recipe parameters to the variation in measurements from each measured location, from each of the experiments. Sensitivity values are then commonly averaged to determine a wafer's average sensitivity to a particular recipe parameter. Sensitivity may be calculated corresponding to averaged radial sensitivity values across a wafer.

The set of experimental data can include a set of predictors corresponding to inputs and a set of responses corresponding to outputs. For example, predictors can be recipe settings, sensor data, or combinations thereof. Responses can include the one or more defect types corresponding to the one or more trained defect models.

In some embodiments, the input training data 220 is not received in a suitable format for training machine learning models. To address this, the defect model training component 212 can convert the input training data 220 into defect model training data having a machine learning format for generating the set of trained defect models 214. In some embodiments, the input training data 220 is received in the machine learning format as defect model training data.

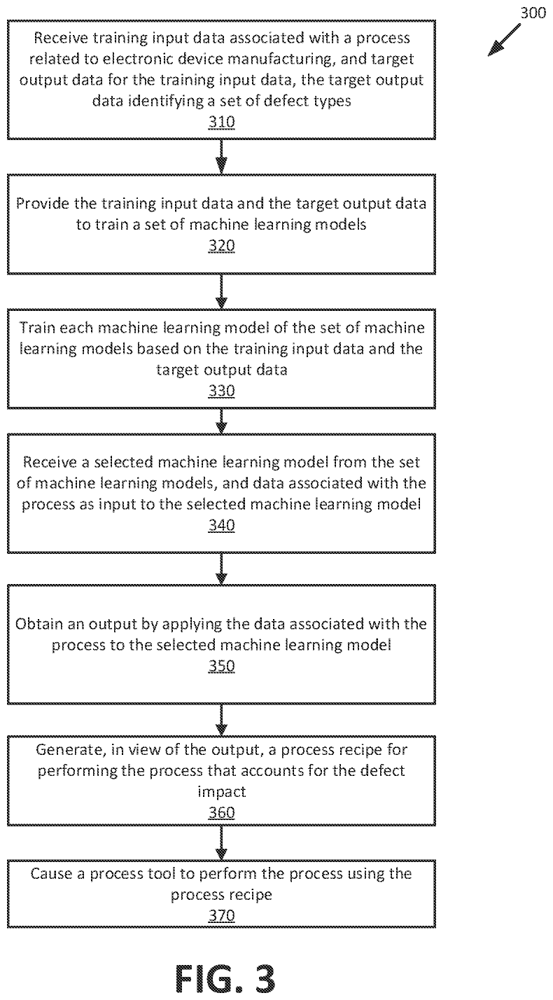

As will be described in further detail below, each trained defect model of the set of trained defect models 214 can be used to model defects of its corresponding defect type during a process related to electronic device manufacturing. For example, a trained defect model can be used to model defects of its corresponding defect type during wafer processing. In some embodiments, a trained defect model is used to estimate an expected defect count using regression type methods (e.g., neural networks, generalized linear models. In some embodiments, a trained defect model can be used to classify input regions based on a probability of defect (e.g., neural network classifiers, logistic regression). Further details regarding receiving the input training data 220 and generating the set of trained defect models 214 will be described in further detail below with reference to FIGS. 3-5.

The machine learning section 210 can further include a trained defect model inference component 216. The trained defect model inference component can receive the set of trained defect models 214 and input inference data 230, and perform, based on the input inference data 230, an inference using the set of trained defect models 214 to generate an inference output 218. The inferencing can be performed to enable interpolation between experimental data points.

The input inference data 230 can include one or more of a set of recipe settings for a process recipe, sensor data, materials data, equipment-related information, etc. defined by defect model type and use case. The inference output 218 can serve as a guide to recipe conditions that are likely to have low defect counts. Additionally or alternatively, the inference output 218 can be used in combination with numerical optimization routines to find recipe conditions that yield on-desired wafer conditions while minimizing defect probability.

For example, in some embodiments, the input inference data 230 includes a set of recipe settings for a process recipe, and the inference output 218 includes an estimated defect count for each of the one or more defect types in view of the set of recipe settings and/or a probability that each of the one or more defect types will impact performance in view of the recipe settings.

In some embodiments, the input inference data 230 includes the set of recipe settings and a set of constraints specifying an allowable range for each setting of the set of recipe settings, and the inference output 218 includes a constrained set of recipe settings that minimizes an estimated defect count for each of the one or more defect types in view of the set of recipe settings and/or a probability that each of the one or more defect types will impact performance in view of the recipe settings.

In some embodiments, the input inference data 230 includes a set of desired characteristics, and the inference output 218 includes a set of recipe settings that achieves the set of desired characteristics while minimizing an estimated defect count for each of the one or more defect types in view of the set of recipe settings and/or a probability that each of the one or more defect types will impact performance in view of the recipe settings. For example, the set of desired characteristics can include a set of performance goals resulting from the performance of the process (e.g., on-wafer performance goals resulting from a wafer process).

Further details regarding receiving the input inference data 230 and generating the inference output 218 will be described in further detail below with reference to FIG. 3. The system 200 can further include a recipe creation component 240. The recipe creation component 240 receives the inference output 218 and generates a recipe 250 having recipe settings based on the inference output. The recipe settings can include a set of recipe parameters and a set of recipe steps. For example, the recipe settings can include one or more relevant recipe parameters for achieving the set of goals. The system 200 can further include an unprocessed substrate or wafer 260 that is received by a tool/chamber 270 to produce a processed wafer 280 using the recipe 250. Feedback from the processing of the tool/chamber 270 can be used to further tune the recipe 250. Although a wafer is shown, any suitable component can be processed in accordance with the embodiments described herein. Further details regarding the operations performed by the recipe creation component 240 and the recipe 250 will be described in further detail below with reference to FIG. 3.

For simplicity of explanation, the methods described herein are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

FIG. 3 is a flow chart of a method for using at least one trained defect model to generate a process recipe, according to aspects of the present disclosure. Method 300 is performed by processing logic that can include hardware (circuitry, dedicated logic, etc.), software (such as is run on a general purpose computer system or a dedicated machine), firmware, or some combination thereof. In one implementation, method 300 can be performed by a computer system, such as computer system architecture 100 of FIG. 1. In other or similar implementations, one or more operations of method 300 can be performed by one or more other machines not depicted in the figures. In some aspects, one or more operations of method 400 can be performed by training set generator 172 of server machine 170.

At block 310, the processing logic receives training input data associated with a process related to electronic device manufacturing, and target output data for the training input data. For example, the training input data can include one or more of a set of experimental data (e.g., supervised and/or unsupervised experimental data), a set of physics models, a set of expert knowledge, etc. The target output data identifies a set of defect types

At block 320, the processing logic provides the training input data and the target output data to train a set of machine learning models. Each machine learning model of the set of machine learning models is trained for identifying defect impact with respect to at least one defect type of the set of defect types. For example, the set of machine learning models can include one or more of a regression model, a classifier model, etc. Accordingly, each machine learning model can be referred to as a defect model.

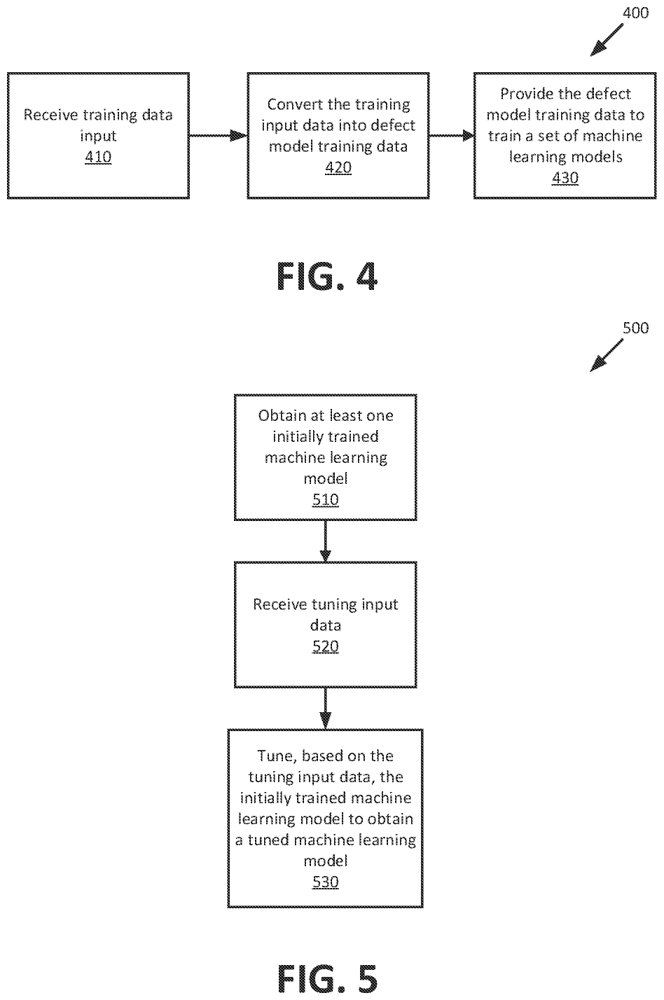

In some embodiments, the training input data is not received in a suitable format for training machine learning models. To address this, providing the training input data can include converting the training input data into defect model training data having a machine learning format. Further details regarding converting the input training data into defect model training data are described below with reference to FIG. 4. Alternatively, training input data can be received in a suitable machine learning format at block 310.

At block 330, the processing logic trains each machine learning model of the set of machine learning models based on the training input data and the target output data. In some embodiments, training each machine learning model of the set of machine learning models includes obtaining one or more initially trained machine learning models, and tuning the one or more initially trained machine learning models. The tuning can be performed to fine-tune and thus improve performance of the one or more initially trained machine learning models. Further details regarding these embodiments will be described below with reference to FIG. 5.

At block 340, the processing logic receives a selected machine learning model from the set of machine learning models, and data associated with the process as input to the selected machine learning model. In some embodiments, the data associated with the process includes process recipe data. For example, the process recipe data can include a set of recipe settings for the process recipe. In some embodiments, the data associated with the process includes sensor data.

At block 350, the processing logic obtains an output by applying the data associated with the process to the selected machine learning model. The output can be representative of a defect impact related to the at least one defect type.

In some embodiments, the data associated with the process includes a set of recipe settings for a process recipe, and the output includes an estimated defect count for each of the one or more defect types in view of the set of recipe settings and/or a probability that each of the one or more defect types will impact performance in view of the recipe settings.

In some embodiments, the data associated with the process includes the set of recipe settings and a set of constraints specifying an allowable range for each setting of the set of recipe settings, and the output includes a constrained set of recipe settings that minimizes an estimated defect count for each of the one or more defect types in view of the set of recipe settings and/or a probability that each of the one or more defect types will impact performance in view of the recipe settings.

In some embodiments, the data associated with the process includes a set of desired characteristics, and the output includes a set of recipe settings that achieves the set of desired characteristics while minimizing an estimated defect count for each of the one or more defect types in view of the set of recipe settings and/or a probability that each of the one or more defect types will impact performance in view of the recipe settings. For example, the set of desired characteristics can include a set of performance goals resulting from the performance of the process (e.g., on-wafer performance goals resulting from a wafer process).

The output can be used to indicate (e.g., predict) defects for performing processing in view of current recipe parameters or inputs. For example, the indication can correspond to a probability of expecting an undesirable defect count. Additionally or alternatively, the output can indicate potential combinations of recipe inputs that can be used to reduce the probability of defects, or otherwise move the process from a high risk process to a low risk process with respect to defects. For example, the output can suggest modifying (e.g., increasing or decreasing) one or more inputs already listed in the recipe, adding one or more new inputs to the recipe, etc.

At block 360, the processing logic generates, in view of the output, a process recipe for performing the process that accounts for the defect impact. The process recipe can include recipe settings to process the component associated with the electronic device. For example, the process recipe can be a recipe used to process a wafer. The recipe settings can include a set of recipe parameters and a set of recipe steps. For example, the recipe settings can include one or more relevant recipe parameters for achieving the set of goals.

At block 370, the processing logic causes a process tool to perform the process using the process recipe. The process tool can be any tool, chamber, etc. used to process the component. For example, the process tool can process a wafer. Feedback from the processing can be used to further tune the recipe (e.g., the recipe settings).

FIG. 4 is a flow chart of a method 400 for obtaining defect model training data used to train a set of machine learning models, according to aspects of the present disclosure. Method 400 is performed by processing logic that can include hardware (circuitry, dedicated logic, etc.), software (such as is run on a general purpose computer system or a dedicated machine), firmware, or some combination thereof. In one implementation, method 400 can be performed by a computer system, such as computer system architecture 100 of FIG. 1. In other or similar implementations, one or more operations of method 400 can be performed by one or more other machines not depicted in the figures. In some aspects, one or more operations of method 400 can be performed by training set generator 172 of server machine 170.

At block 410, the processing logic receives training input data. The training input data can be similar to the training input described above with reference to FIGS. 2 and 3. It is assumed in this example that the input training data is not received in a suitable format for training machine learning models.

To address this, at block 420, the processing logic converts the training input data into defect model training data. The defect model training data has a suitable machine learning format that can be used to train a machine learning model. For example, converting the training input data into the defect model training data can include translating (e.g., re-coding) the training input data into the machine learning format for use in a machine learning pipeline.

At block 430, the processing logic provides the defect model training data to train a set of machine learning models. For example, the defect model training data can be provided with target output data. Further details regarding blocks 410-430 are described above with reference to FIGS. 2 and 3.

FIG. 5 is a flow chart of a method 500 for tuning at least one initial trained defect model to generate at least one trained defect model, according to aspects of the present disclosure. Method 500 is performed by processing logic that can include hardware (circuitry, dedicated logic, etc.), software (such as is run on a general purpose computer system or a dedicated machine), firmware, or some combination thereof. In one implementation, method 500 can be performed by a computer system, such as computer system architecture 100 of FIG. 1. In other or similar implementations, one or more operations of method 500 can be performed by one or more other machines not depicted in the figures. In some aspects, one or more operations of method 600 can be performed by predictive server 112.

At block 510, the processing logic obtains at least one initially trained machine learning model. The initially trained machine learning model can be trained for identifying defect impact with respect to at least one defect type of the set of defect types. For example, the initially trained machine learning model can be a regression model, a classifier model, etc. Accordingly, the initially trained machine learning model can be referred to as an initially trained defect model. For example, the initially trained machine learning model can be generated based on training input data and target output data, as described above with reference to FIGS. 2-4.

At block 520, the processing logic receives tuning input data. For example, the tuning input data can include validation data. Validation data includes data that had been withheld during the training performed to obtain the initially trained machine learning model.

At block 530, the processing logic tunes, based on the input tuning data, the initially trained defect model to obtain a tuned machine learning model. For example, tuning the initially trained defect model can include modifying one or more parameters (e.g., hyperparameters) of the initial trained defect model to achieve a more accurate model result.

In some embodiments, the tuning input data received at block 520 is not provided in a suitable machine learning format for tuning the initially trained machine learning model. To address this, tuning the initially trained machine learning model can include converting the tuning input data into defect model tuning data having a machine learning format for tuning the initially trained defect model. For example, converting the tuning input data into the defect model tuning data can include translating (e.g., re-coding) the tuning input data into the machine learning format for use in a machine learning pipeline. In some embodiments, the tuning input data received at block 520 is provided in a suitable machine learning format for tuning the initially trained machine learning model.

FIG. 6 depicts a block diagram of an illustrative computing device 600 operating in accordance with one or more aspects of the present disclosure. In alternative embodiments, the machine can be connected (e.g., networked) to other machines in a Local Area Network (LAN), an intranet, an extranet, or the Internet. The machine can operate in the capacity of a server or a client machine in a client-server network environment, or as a peer machine in a peer-to-peer (or distributed) network environment. The machine can be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In embodiments, computing device 600 can correspond to predictive server 112 of FIG. 1 or another processing device of system 100.

The example computing device 600 includes a processing device 602, a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a secondary memory (e.g., a data storage device 628), which communicate with each other via a bus 608.

Processing device 602 can represent one or more general-purpose processors such as a microprocessor, central processing unit, or the like. More particularly, the processing device 602 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. Processing device 602 can also be or include a system on a chip (SoC), programmable logic controller (PLC), or other type of processing device. Processing device 602 is configured to execute the processing logic for performing operations and steps discussed herein.

The computing device 600 can further include a network interface device 622 for communicating with a network 664. The computing device 600 also can include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 628 can include a machine-readable storage medium (or more specifically a non-transitory computer-readable storage medium) 624 on which is stored one or more sets of instructions 626 embodying any one or more of the methodologies or functions described herein. Wherein a non-transitory storage medium refers to a storage medium other than a carrier wave. The instructions 626 can also reside, completely or at least partially, within the main memory 604 and/or within the processing device 602 during execution thereof by the computer device 600, the main memory 604 and the processing device 602 also constituting computer-readable storage media.

The computer-readable storage medium 624 can also be used to store model 190 and data used to train model 190. The computer readable storage medium 624 can also store a software library containing methods that call model 190. While the computer-readable storage medium 624 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of operations of each method can be altered so that certain operations can be performed in an inverse order so that certain operations can be performed, at least in part, concurrently with other operations. In another embodiment, instructions or sub-operations of distinct operations can be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving, by a processing device, training input data associated with a process related to electronic device manufacturing, the training input data comprising a set of experimental data related to the process;
obtaining, by the processing device, target output data for the training input data, the target output data identifying a set of defect types; and
providing, by the processing device, the training input data and the target output data to train a set of machine learning models, wherein each machine learning model of the set of machine learning models is trained for identifying defect impact with respect to at least one type defect type of the set of defect types.

2. The method of claim 1, further comprising converting, by the processor device, the training input data into defect model training data having a machine learning format for training the set of machine learning models.

3. The method of claim 1, further comprising:
receiving, by the processing device, an initially trained machine learning model from the set of machine learning models;
receiving, by the processing device, tuning input data; and
tuning, based on the tuning input data, the initially trained machine learning model to obtain a tuned machine learning model.

4. The method of claim 1, further comprising:
receiving, by the processing device, a selected machine learning model from the set of machine learning models;
receiving, as input to the selected machine learning model, data associated with the process; and
obtaining an output by applying the data associated with the process to the selected machine learning model, wherein the output is representative of the defect impact with respect to the at least one defect type.

5. The method of claim 4, wherein the data associated with the process recipe comprises a set of recipe settings for a process recipe, and wherein the output includes at least one of: an estimated defect count for the at least one defect type in view of the set of recipe settings, or a probability that the at least one defect type will impact performance in view of the recipe settings.

6. The method of claim 4, wherein:
the data associated with the process recipe comprises a set of recipe settings for a process recipe, and a set of constraints specifying an allowable range for each setting of the set of recipe settings; and
the output comprises a constrained set of recipe settings that minimizes at least one of: an estimated defect count for the at least one defect type in view of the set of recipe settings, or a probability that the at least one defect type will impact performance in view of the recipe settings.

7. The method of claim 4, wherein:
the data associated with the process recipe comprises a set of desired characteristics; and
the output comprises a set of recipe settings that achieves the set of desired characteristics while minimizing at least one of: an estimated defect count for the at least one defect type in view of the set of recipe settings, or a probability that the at least one defect type will impact performance in view of the recipe settings.

8. The method of claim 4, further comprising:
generating, by the processing device in view of the output, a process recipe for performing the process that accounts for the defect impact with respect to the at least one defect type; and
causing, by the processing device, a process tool to perform the process using the process recipe.

9. A system comprising:
a memory and
a processing device, operatively coupled to the memory, to perform operations comprising:
receiving, as input to a trained machine learning model for identifying defect impact with respect to at least one type defect type, data associated with a process related to electronic device manufacturing, wherein the data associated with the process comprises at least one of: an input set of recipe settings for processing a component, a set of desired characteristics to be achieved by processing the component, or a set of constraints specifying an allowable range for each setting of the set of recipe settings; and
obtaining an output by applying the data associated with the process to the trained machine learning model, wherein the output is representative of the defect impact with respect to the at least one defect type.

10. The system of claim 9, wherein the output comprises at least one of: an estimated defect count for the at least one defect type in view of the set of recipe settings, or a probability that the at least one defect type will impact performance in view of the recipe settings.

11. The system of claim 9, wherein the output comprises an output set of recipe settings that minimizes at least one of: an estimated defect count for the at least one defect type in view of the set of recipe settings, or a probability that the at least one defect type will impact performance in view of the set of recipe settings.

12. The system of claim 11, wherein the operations further comprise generating a process recipe based on the output set of recipe settings for performing the process that accounts for the defect impact with respect to the at least one defect type.

13. The system of claim 12, wherein the operations further comprise causing a process tool to perform the electronic device manufacturing process using the process recipe.

14. The system of claim 9, wherein the operations further comprise, prior to receiving the data, obtaining the trained machine learning model by training a machine learning model based on training input data and target output data, and wherein the training input data comprises a set of experimental data related to the process.

15. A non-transitory machine-readable storage medium storing instructions which, when executed by a processing device, cause the processing device to perform operations comprising:
receiving, as input to a trained machine learning model for identifying defect impact with respect to at least one type defect type, data associated with a process related to electronic device manufacturing, wherein the data associated with the process comprises at least one of: an input set of recipe settings for processing a component, a set of desired characteristics to be achieved by processing the component, or a set of constraints specifying an allowable range for each setting of the set of recipe settings; and
obtaining an output by applying the data associated with the process to the trained machine learning model, wherein the output is representative of the defect impact with respect to the at least one defect type.

16. The non-transitory machine-readable storage medium of claim 15, wherein the output comprises at least one of: an estimated defect count for the at least one defect type in view of the set of recipe settings, or a probability that the at least one defect type will impact performance in view of the recipe settings.

17. The non-transitory machine-readable storage medium of claim 15, wherein the output comprises an output set of recipe settings that minimizes at least one of: an estimated defect count for the at least one defect type in view of the set of recipe settings, or a probability that the at least one defect type will impact performance in view of the set of recipe settings.

18. The non-transitory machine-readable storage medium of claim 17, wherein the operations further comprise generating a process recipe based on the output set of recipe settings for performing the process that accounts for the defect impact with respect to the at least one defect type.

19. The non-transitory machine-readable storage medium of claim 18, wherein the operations further comprise causing a process tool to perform the process using the process recipe.

20. The non-transitory machine-readable storage medium of claim 15, wherein the operations further comprise, prior to receiving the data, obtaining the trained machine learning model by training a machine learning model based on training input data and target output data, and wherein the training input data comprises a set of experimental data related to the process.
